(19) United States
(12) Patent Application Publication
(10) Pub. No.: US 2021/0270175 A1
(43) Pub. Date: Sep. 2, 2021

(54) AUTOMOBILE EXHAUST HEAT RECOVERY DEVICE

(71) Applicant: SANKEI GIKEN KOGYO CO., LTD., Tokyo (JP)

(72) Inventor: Takanori Nagai, Isesaki-shi (JP)

(73) Assignee: SANKEI GIKEN KOGYO CO., LTD., Tokyo (JP)

(21) Appl. No.: 17/256,723

(22) PCT Filed: May 17, 2019
(86) PCT No.: PCT/JP2019/019743

§ 371 Date: Dec. 29, 2020

(30) Foreign Application Priority Data
Aug. 6, 2018 (JP) 2018-147450

(51) Int. Cl. F01N 5/02; F01N 13/08

(52) U.S. Cl. CPC F01N 5/02; F01N 13/08

(57) ABSTRACT

An automobile exhaust heat recovery device 1 includes: a base structure 2 in which first fluid flows; and flat flow tubes 5m and 5n which extend at an angle with respect to a flowing direction of the first fluid and in which a flat surface is provided so as to follow the flowing direction of the first fluid and second fluid that exchanges heat with the first fluid flows. An upstream-side flat flow tube group and a downstream-side flat flow tube group in the flowing direction of the first fluid are configured such tint a plurality of flat flow tubes 5m and a plurality of flat flow tubes 5n are arranged side by side at intervals in a direction substantially perpendicular to the flowing direction of the first fluid. An upstream-side end 51n in the flowing direction of the first fluid, of the downstream-side flat flow tube 5n is provided.

### TECHNICAL FIELD

The present invention relates to an exhaust heat recovery device that recovers and uses exhaust heat such as exhaust gas of an internal combustion engine of an automobile.

### BACKGROUND ART

Conventionally, a device that heats cooling water with exhaust heat of exhaust generated in an internal combustion engine of an automobile and recovers the exhaust heat is known. For example. Patent Literature 1 discloses an automobile exhaust heat recovery device including: an exhaust gas introducing portion into which exhaust gas generated by an internal combustion engine is introduced, a heat recovery path connected to an upper portion on the downstream side of the exhaust gas introducing portion, a detour provided in a lower portion of the heat recovery path and connected to a lower portion on the downstream side of the exhaust gas introducing portion, a heat recovery device mounted on an upper surface of the detour to heat cooling water with the exhaust sent from the heat recovery path, and a valve provided rotatably on the upstream or downstream side of the detour and the heat recovery path to close either the detour or the heat recovery path to regulate the flow of exhaust. The heat recovery device of this exhaust heat recovery device is provided with a plurality of flat tubular heat plates through which exhaust gas is passed in a core case, and the cooling water flowing in the core case is heated with the heat of the exhaust gas flowing through the heat plates.

### CITATION LIST

### Patent Literature

Patent Literature 1: Japanese Patent Application Publication No. 2012-31756

### SUMMARY OF INVENTION

### Technical Problem

By the way, in the automobile exhaust heat recovery device, in addition to the demand for higher heat exchange efficiency, a structure capable of discharging fluid that performs heat exchange such as cooling water to the same side as an introduction side according to the state of the installation location in a vehicle is also required.

The present invention is proposed in view of the above-mentioned problem and an object thereof is to provide an automobile exhaust heat recovery device capable of increasing heat exchange efficiency remarkably, discharging fluid that performs heat exchange such as cooling water to the same side as an introduction side, and increasing the degree of freedom of an installation location in a vehicle.

### Solution to Problem

An automobile exhaust heat recovery device of the present invention includes: a base structure in which first fluid flows; and flat flow tubes which extend at an angle with respect to a flowing direction of the first fluid and in which a flat surface is provided so as to follow the flowing direction of the first fluid and second fluid that exchanges heat with the first fluid flows, an upstream-side flat flow tube group and a downstream-side flat flow tube group in the flowing direction of the first fluid are configured such that a plurality of flat flow tubes are arranged side by side at intervals in a direction substantially perpendicular to the flowing direction of the first fluid, an upstream-side end in the flowing direction of the first fluid in the flat flow tube of the downstream-side flat flow tube group is provided so as not to overlap the flat flow tube of the upstream-side flat flow tube group in the flowing direction of the first fluid, and a flow path through which the second fluid flows is configured so as to make a U-turn between the upstream-side flat flow tube group and the downstream-side flat flow tube group.

According to this configuration, since the flat surfaces of the flat flow tubes follow the flowing direction of the first fluid, and the plurality of flat flow tubes are arranged side by side at intervals, a heat exchange area can be increased. Moreover, since the upstream-side end in the flowing direction of the first fluid in the downstream-side flat flow tube does not overlap the upstream-side flat flow tube, the first fluid having a large temperature difference from the second fluid can reach the downstream-side flat flow tube and the heat exchange performance can be increased. Therefore, it is possible to enhance the heat exchange efficiency remarkably. Due to the structure in which the second fluid flows between the upstream-side flat flow tube group and the downstream-side flat flow tube group while making a U-turn, it is possible to lead a fluid that performs heat exchange such as cooling water to the same side as the introduction side and increase the degree of freedom of an installation location of the automobile exhaust heat recovery device in a vehicle. Moreover, due to the flat shape and the arrangement of the flat flow tubes, it is possible to reduce the pressure loss of the first fluid flowing in the base structure and secure the smooth flow of the first fluid. When the first fluid is the exhaust gas of an internal combustion engine of an automobile, it is possible to reduce the back pressure of the internal combustion engine due to the reduction of the pressure loss and improve the exhaust efficiency, the intake efficiency, and the combustion efficiency of the internal combustion engine.

In the automobile exhaust heat recovery device of the present invention, the upstream-side flat flow tube group and the downstream-side flat flow tube group are collectively inserted into the same heat transfer fin, and a plurality of heat transfer fins are provided at intervals in a pipeline direction in which the upstream-side flat flow tube group and the downstream-side flat flow tube group extend.

According to this configuration, since the plurality of heat transfer fins are provided at intervals in the pipeline direction in which the upstream-side flat flow tube group and the downstream-side flat flow tube group extend, it is possible to further enhance the heat exchange efficiency. Since the upstream-side flat flow tube group and the downstream-side flat flow tube group are inserted into the same heat transfer fin, it is possible to easily integrate and assemble the upstream-side flat flow tube group and the downstream-side flat flow tube group by attachment of the heat transfer fin.

The automobile exhaust heat recovery device of the present invention further includes: a first partitioning portion in which openings at one set of ends of the flat flow tubes of the upstream-side flat flow tube group are open; and a second partitioning portion in which openings at one set of ends of the flat flow tubes of the downstream-side flat flow tube group are open and which is partitioned from the first partitioning portion, wherein the second fluid is introduced from the outside into one of the first and second partitioning portions, and the second fluid is led outside from the other partitioning portion, and a U-turn partitioning portion in which openings at the other set of ends of the flat flow tubes of the upstream-side flat flow tube group and openings at the other set of ends of the flat flow tubes of the downstream-side flat flow tube group are open is provided.

According to this configuration, introduction and lead-out of the second fluid to the upstream-side flat flow tube group and the downstream-side flat flow tube group can be performed easily. Moreover, since the U-turn partitioning portion eliminates the need for a complex structure such as shifting the upstream-side flat flow tubes in the stacking direction of the flat flow tubes so as to be connected to the downstream-side flat flow tubes, it is possible to simplify the structure for allowing the second fluid to make a U-turn and realize the structure at a low cost. Moreover, since the second fluid led out from the flat flow tubes of the upstream-side or the downstream-side is mixed inside the U-turn partitioning portion, it is possible to promote turbulence and stirring to suppress temperature unevenness and further enhance the heat exchange efficiency.

In the automobile exhaust heat recovery device of the present invention, the base structure is formed by bonding a pair of half bodies so as to be aligned in a pipeline direction of the flat flow tubes, and both ends of the flat flow tubes are fitted and welded to a penetration hole of one half body and a penetration hole of the other half body.

According to this configuration, the flat flow tubes can be positioned easily and reliably with respect to the base structure and the pair of half bodies bonded so as to be aligned in the pipeline direction of the flat flow tubes, and the flat flow tubes can be fixed in a bridged state.

In the automobile exhaust heat recovery device of the present invention, the base structure is formed by bonding a pair of half bodies so as to be aligned in a pipeline direction of the flat flow tubes, and a fitting portion provided in a mating portion of one half body is fitted to a fitting target portion provided in a mating portion of the other half body.

According to this configuration, one half body and the other half body which are bonded so as to be aligned in the pipeline direction of the flat flow tubes can be positioned and aligned at an accurate position, the manufacturing operation can be facilitated, and the yield can be improved.

The automobile exhaust heat recovery device of the present invention further includes: the base structure which includes a fluid introducing portion, a fluid lead-out portion, and a bulging portion between the fluid introducing portion and the fluid lead-out portion and which is formed by bonding a pair of half bodies so as to be aligned in a pipeline direction of the flat flow tubes; a separator that extends in the flowing direction of the first fluid flowing in the base structure and divides the inside of the bulging portion substantially into a heat exchange path and a detour; and a tilt valve that is switchable so that the flow of the first fluid flowing in the base structure is regulated to either the heat exchange path or the detour, wherein the upstream-side flat flow tube group and the downstream-side flat flow tube group are provided such that the first fluid flowing in the heat exchange path flows around the flat flow tube groups.

According to this configuration, since the heat exchange path and the detour can be formed by the base structure formed by bonding a pair of half bodies and the separator that substantially divides the inside of the bulging portion of the base structure, it is possible to form the automobile exhaust heat recovery device having the switchable heat exchange path and the detour with a small number of parts. Therefore, since the number of parts to be bonded decreases, it is possible to improve the manufacturing efficiency and decrease the cost of parts and the cost of bonding operations to reduce the manufacturing cost. Moreover, since the number of parts decreases, it is possible to reduce the weight of the automobile exhaust heat recovery device and improve the fuel efficiency of an automobile due to weight reduction.

In the automobile exhaust heat recovery device of the present invention, the separator, the tilt valve, and the flat flow tube are bridged between the half bodies. According to this configuration, the separator, the tilt valve, and the flat flow tube can be easily installed in the base structure in cooperation with an operation of aligning a pair of half bodies in the pipeline direction of the flat flow tubes.

### ADVANTAGEOUS EFFECTS OF INVENTION

According to the automobile exhaust heat recovery device of the present invention, it is possible to increase heat exchange efficiency remarkably, lead fluid that performs heat exchange such as cooling water to the same side as an introduction side, and increase the degree of freedom of an installation location in a vehicle.

### BRIEF DESCRIPTION OF DRAWINGS

FIG. 1 is a perspective view of an automobile exhaust heat recovery device according to an embodiment of the present invention.

FIG. 2 is an exploded perspective view of the automobile exhaust heat recovery device according to the embodiment.

FIG. 3 is a perspective view illustrating a state in which a flat flow tube, a separator, and a tilt valve is disposed in one half body of the automobile exhaust heat recovery device according to the embodiment.

FIG. 4 is a front view of the other half body and a partitioning unit of the automobile exhaust heat recovery device according to the embodiment, as viewed from the inner side.

FIG. 5 is a front view of a state in which the other half body is removed from the state of FIG. 4.

FIG. 6(a) is a cross-sectional view of a flat flow tube, a heat transfer fin, a partitioning unit, and a U-turn partitioning portion of the automobile exhaust heat recovery device according to the embodiment, and FIG. 6(b) is a front view of the assembly of the flat flow tube and the heat transfer fin of the automobile exhaust heat recovery device according to the embodiment.

FIG. 7 is a partial longitudinal view illustrating a heat exchange operation of the automobile exhaust heat recovery device according to the embodiment.

### DESCRIPTION OF EMBODIMENTS

### Automobile Exhaust Heat Recovery Device According to Embodiment

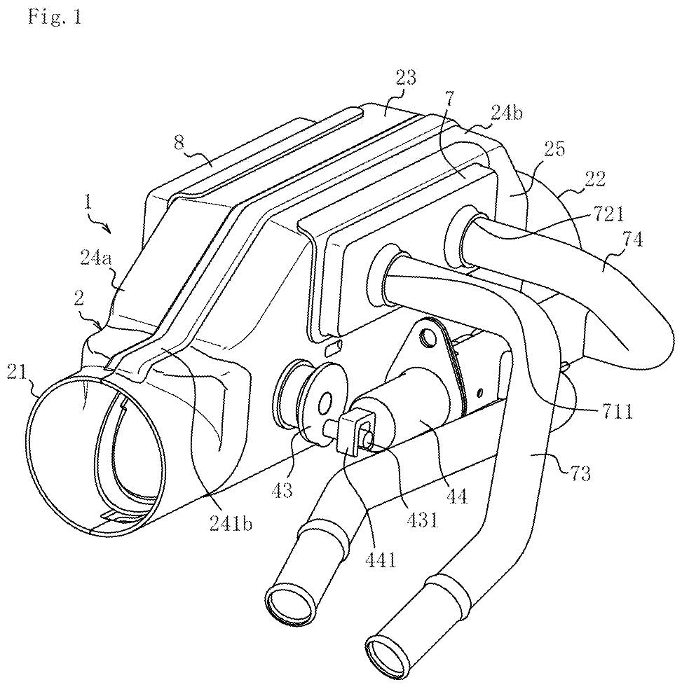

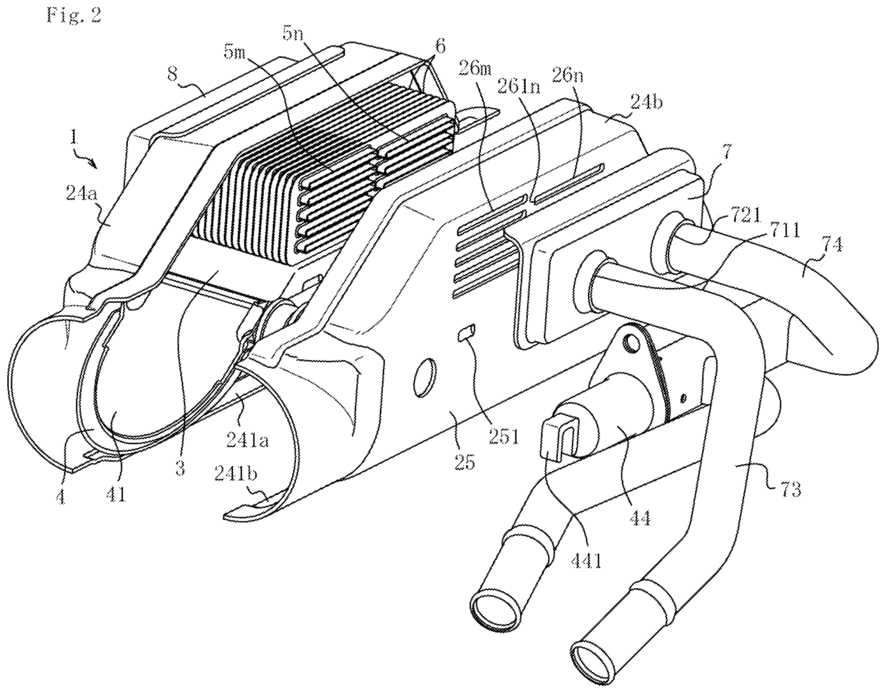

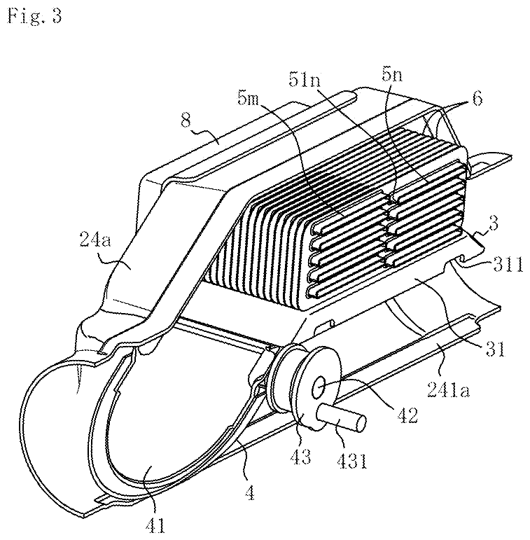

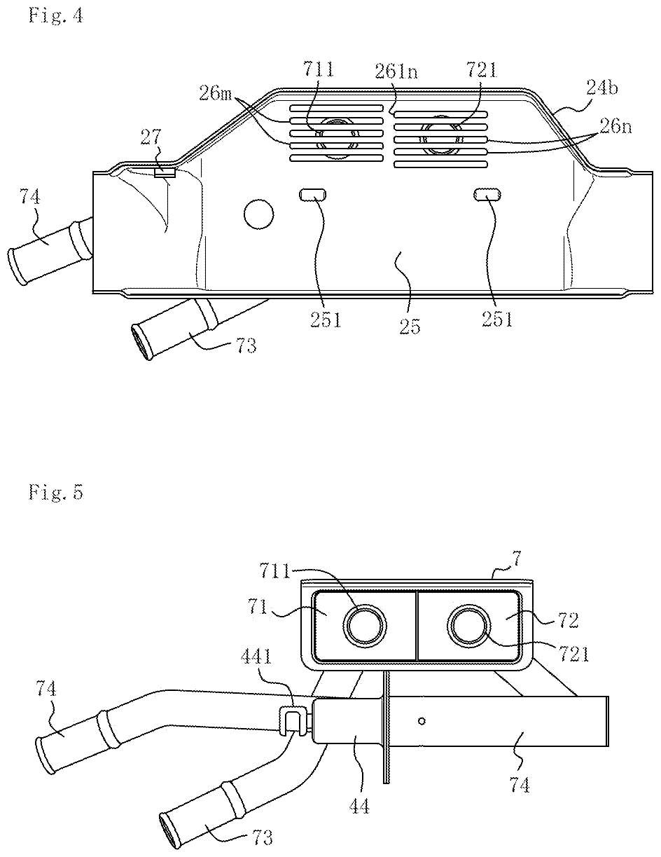

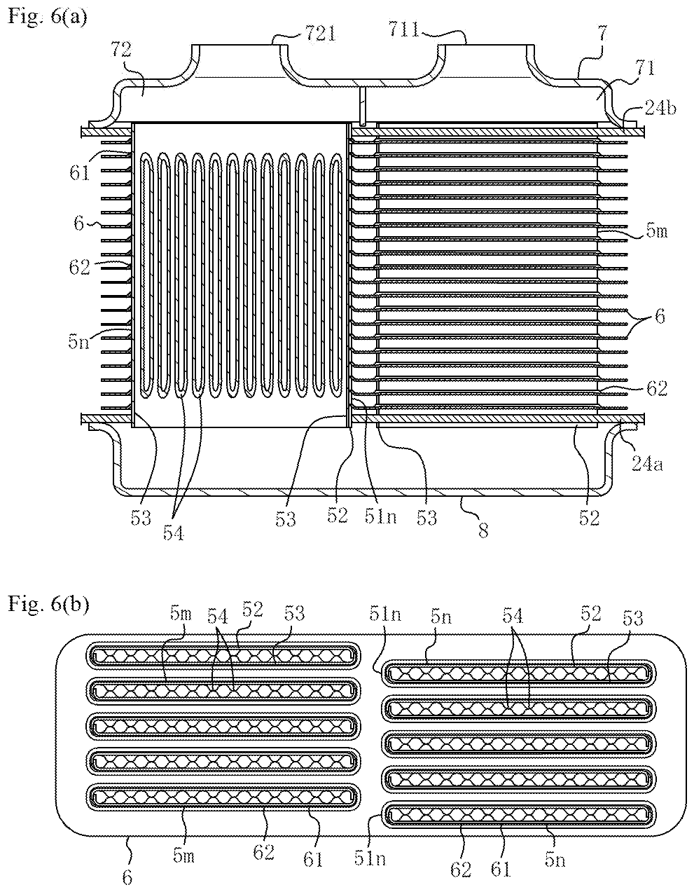

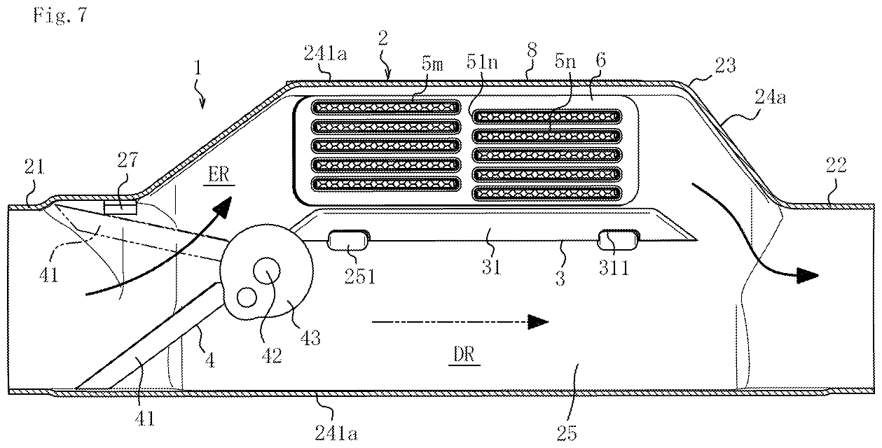

As illustrated in FIGS. 1 to 7, an automobile exhaust heat recovery device 1 according to an embodiment of the present invention includes a base structure 2 in which first fluid flows. The base structure 2 includes a substantially cylindrical fluid introducing portion 21, a substantially cylindrical fluid lead-out portion 22, a bulging portion 23 provided between the fluid introducing portion 21 and the fluid lead-out portion 22. The bulging portion 23 bulges outward so that a wide space is formed therein, and the base structure 2 is a substantially tubular shape having a bulge in a middle portion as a whole. The base structure 2 of the illustrated example is formed such that the axis of the substantially cylindrical fluid introducing portion 21 and the axis of the substantially cylindrical fluid lead-out portion 22 substantially coincide with each other, and the bulging portion 23 is formed so as to project in one lateral side from the fluid introducing portion 21 and the fluid lead-out portion 22.

The base structure 2 is formed by bonding a pair of half bodies 24a and 24b. The half bodies 24a and 24b have a shape obtained by bisecting the base structure 2 in the axial direction of the fluid introducing portion 21 and the fluid lead-out portion 22 and the projecting direction of the bulging portion 23, and the half bodies 24a and 24b have substantially the same shape and substantially the same size. The pair of half bodies 24a and 24b of the present embodiment are bonded so as to be aligned in a pipeline direction of flat flow tubes 5m and 5n described later.

The mating portions of the half bodies 24a and 24b are formed such that end surfaces thereof abut each other at the upstream-side end of the fluid introducing portion 21 and the downstream-side end of the fluid lead-out portion 22 and intermediate portions thereof inflate outward due to a height difference of a fitting portion 241a and a fitting target portion 241b so that the fitting portion 241a is fitted to an inner portion of the fitting target portion 241b. The abutting end surfaces and an overlapping surface of the fitting portion 241a and the fitting target portion 241b or the end portion of the fitting target portion 241b are welded by laser welding or the like and the half bodies 24a and 24b are bonded and integrated as the base structure 2.

A mounting portion 251 is formed at a predetermined position in a wall portion 25 corresponding to the bulging portion 23 of the base structure 2 so as to be recessed inward, and a separator 3 described later is positioned and mounted on the mounting portion 251. The mounting portion 251 is formed on each of the half bodies 24a and 24b and is provided on both sides of the base structure 2. A shaft portion 42 of a tilt valve 4 described later is tiltably supported on both wall portions 25 corresponding to the bulging portion 23 of the base structure 2 (that is, the wall portion 25 of one half body 24a and the wall portion 25 of the other half body 24b) so as to be bridged.

Upstream-side penetration holes 26m and downstream-side penetration holes 26n in the flowing direction of the first fluid are provided in both wall portions 25 corresponding to the bulging portion 23 of the base structure 2 (that is, the wall portion 25 of one half body 24a and the wall portion 25 of the other half body 24b). The penetration holes 26m and 26n are elongated holes extending in the pipeline direction of the substantially tubular base structure 2 and are formed at positions closer to the projecting direction of the bulging portion 23.

A plurality of upstream-side penetration holes 26m of one half body 24a and a plurality of upstream-side penetration holes 26m of the other half body 24b are arranged side by side at intervals in a direction substantially perpendicular to the flowing direction of the first fluid (that is, in a bulging direction of the bulging portion 23), and a plurality of pairs of penetration holes 26m are provided at positions corresponding to the wall portions 25. A plurality of downstream-side penetration holes 26n of one half body 24a and a plurality of downstream-side penetration holes 26n of the other half body 24b are arranged side by side at intervals in a direction substantially perpendicular to the flowing direction of the first fluid (that is, in a bulging direction of the bulging portion 23), and a plurality of pairs of penetration holes 26n are provided at positions corresponding to the wall portions 25.

An upstream-side end 261n in the flowing direction of the first fluid, of the downstream-side penetration hole 26n is disposed so as not to overlap the upstream-side penetration hole 26m in the flowing direction of the first fluid. Flat flow tubes 5m and 5n are inserted in the upstream-side penetration holes 26m and the downstream-side penetration holes 26n so as to be bridged, and both ends of the flat flow tubes 5m and 5n are fitted and welded to the peripheral edges of the penetration holes 26m and 26n, respectively.

The separator 3 that substantially divides the inside of the bulging portion 23 into a heat exchange path ER and a detour DR is provided inside the bulging portion 23 so as to extend in the flowing direction of the first fluid that flows in the base structure 2. The separator 3 of the illustrated example has a substantially rectangular tray shape and is disposed so that the recess side of the tray is the fluid introducing portion 21 and the fluid lead-out portion 22, and recesses 311 of side walls 31 on both sides thereof is mounted and positioned so as to engage with the mounting portions 251. The positioned separator 3 is provided at a position closer to a projecting side of the bulging portion 23 than the pipeline of the fluid introducing portion 21 and the fluid lead-out portion 22.

The separator 3 is fixed to the base structure 2 by the side wails 31 thereof being bonded, by laser welding or the like, to the wall portions 25 of the base structure 2, and the separator 3 is bridged between the half bodies 24a and 24b. A required slit may be formed in the wall portions 25 of the half bodies 24a and 24b and the side walls 31 of the separator 3 may be pressed against the slits and be fixed by plug welding or fillet welding.

A tilt valve 4 that can be switched so that the flow of the first fluid flowing in the base structure 2 is regulated to either the heat exchange path ER or the detour DR is provided on the upstream side in the flowing direction of the first fluid, of the separator 3. The tilt valve 4 includes a substantially tongue-shaped valve plate 41 and a shaft portion 42 fixed to the base of the valve plate 41 and is bridged and tiltably supported between the half bodies 24a and 24b. A driving plate 43 and a driving lever 441 of a thermal actuator 44 attached by engaging with a projection 431 projecting outward from the driving plate 43 are provided in the shaft portion 42 of the tilt valve 4 projecting outward from the other half body 24b, and the tilt valve 4 is opened and closed by being tilted via the driving plate 43 by a reciprocating operation of the driving lever 441. The thermal actuator 44 of the illustrated example is disposed to be adjacent to a pipe 74 described later so as to be able to detect the temperature of a heating target fluid led out from the flat flow tube 5n so as to correspond to a configuration in which a heating target fluid corresponding to second fluid is led out from the pipe 74 after exchanging heat. The tilt valve 4 may be provided on the downstream side of the separator 3.

The flat tubular upstream-side flat flow tube 5m and downstream-side flat flow tube 5n in which the second fluid that exchanges heat with the first fluid are bridged between the half bodies 24a and 24b at a position closer to the projecting direction of the bulging portion 23 than the separator 3. The flat flow tubes 5m and 5n extend with an angle with respect to the flowing direction of the first fluid, which is the pipeline direction of the substantially tubular base structure 2, and in the present embodiment, the flat flow tubes extend substantially at a right angle with respect to the flowing direction of the first fluid. The flat surfaces of the flat flow tubes 5m, 5m are provided so as to follow the flowing direction of the first fluid.

A plurality of upstream-side flat flow tubes 5m in the flowing direction of the first fluid are arranged side by side at intervals in a direction substantially perpendicular to the flowing direction of the first fluid (that is, the plurality of flat flow tubes 5m arranged side by side at intervals in the bulging direction of the bulging portion 23 form an upstream-side flat flow tube group). A plurality of downstream-side flat flow tubes 5n in the flowing direction of the first fluid are arranged side by side at intervals in a direction substantially perpendicular to the flowing direction of the first fluid (that is, the plurality of flat flow tubes 5n arranged side by side at intervals in the bulging direction of the bulging portion 23 form a downstream-side flat flow tube group).

The upstream-side end 5m in the flowing direction of the first fluid, of the flat flow tube 5n of the downstream-side flat flow tube group is provided so as not to overlap the flat flow tube 5m of the upstream-side flat flow tube group in the flowing direction of the first fluid. The upstream-side flat flow tube group and the downstream-side flat flow tube group or the flat flow tubes 5m of the upstream-side flat flow tube group and the flat flow tubes 5n of the downstream-side flat flow tube group are provided so that the first fluid flowing in the heat exchange path ER can flow around each flat flow tube group or each flat flow tube.

The flat flow tubes 5m and 5n of the illustrated example are formed by arranging one plate 51 and the other plate 53 having a substantially C-shape in a cross-sectional view so as to face each other at an interval in the thickness direction. A plurality of supporting portions 54 that support the thickness of the flat flow tubes 5m and 5n are arranged at intervals in the width direction of the flat flow tubes 5m and 5n so as to project inward in a convex shape along the pipeline direction. In this way, it is possible to promote turbulence and heat exchange of the flow of the second fluid flowing inside the flat flow tubes 5m and 5n and enhance the fixing strength of the flat flow tubes 5m and 5n and heat transfer fins 6 described later to improve impact resistance and durability. The configuration of the upstream-side flat flow tube and the downstream-side flat flow tube of the present invention is not limited thereto but can be appropriately modified within the scope of the spirit of the present invention.

A plurality of heat transfer fins 6 are provided by being externally inserted at predetermined intervals in the pipeline direction of the flat flow tubes 5m and 5n, and the heat transfer fins 6 increase the heat transfer area for the heat exchange. A tapered edge 62 is formed in each of insertion holes 61 of the heat transfer fins 6, and the flat flow tubes 5m and 5n are inserted into the insertion holes 61 of the heat transfer fins 6 and are press-fitted and held at the tapered edges 62 of the heat transfer fins 6. That is, due to the press-fitting and holding of the tapered edges 62, the heat transfer fins 6 are fixed to the upstream-side flat flow tube 5m and the downstream-side flat flow tube 5n. The upstream-side flat flow tube group composed of the flat flow tubes 5m and the downstream-side flat flow tube group composed of the flat flow tubes 5n are collectively inserted into the same heat transfer fins 6, and the plurality of heat transfer fins 6 are arranged side by side at intervals in the pipeline direction along which the upstream-side flat flow tube group and the downstream-side flat flow tube group extend.

A partitioning unit 7 having a substantially tray shape for introducing and leading out the second fluid to circulate in the flat flow tubes 5m and 5n is provided on the outer side of the upstream-side penetration hole 26m and the downstream-side penetration hole 26n of the other half body 24b. The partitioning unit 7 includes a first partitioning portion 71 in which openings at one set of ends of the flat flow tubes 5n of the upstream-side flat flow tube group are open and a second partitioning portion 72 in which openings at one set of ends of the flat flow tubes 5n of the downstream-side flat flow tube group are open and which is partitioned from the first partitioning portion 71, and the flat flow tubes 5m and 5n are provided continuously in the space of the first partitioning portion 71 and the space of the second partitioning portion 72, respectively.

A pipe 73 is connected to a connection hole 711 of the first partitioning portion 71, and a pipe 74 is connected to a connection hole 721 of the second partitioning portion 72. One of the pipes 73 and 74 is an introduction pipe that introduces the second fluid for heat exchange from the outside and the other pipe is a lead-out pipe that leads the second fluid for which heat exchange is completed to the outside. The second fluid is introduced from the outside into one of the first and second partitioning portions 71 and 72, and the second fluid is led out from the other partitioning portion. The partitioning unit 7 is disposed along the other half body 24b of the base structure 2 and is fixed by welding or the like to the base structure 2 or the other half body 24b.

A substantially tray-shaped U-turn partitioning portion 8 that forms a flow path in which the second fluid flows by making a U-turn between the upstream-side flat flow tube group and the downstream-side flat flow tube group is provided on the outer side of the upstream-side penetration hole 26m and the downstream-side penetration hole 26n of one half body 24a. Openings at the other set of ends of the flat flow tubes 5m of the upstream-side flat flow tube group are open to the U-turn partitioning portion 8, openings at the other set of ends of the flat flow tubes 5n of the downstream-side flat flow tube group are open to the U-turn partitioning portion 8, and the flat flow tubes 5m and 5n are provided continuously in the space of the U-turn partitioning portion 8. The U-turn partitioning portion 8 is disposed along one half body 24a of the base structure 2 and is fixed by welding or the like to the base structure 2 or one half body 24a.

In the automobile exhaust heat recovery device 1 of the present embodiment, the base structure 2 is connected to an exhaust pipeline of an internal combustion engine of an automobile and an exhaust gas which is a heating fluid flows in the base structure 2 as the first fluid. A heating target fluid such as, for example, cooling water, oil, air, or the like circulates in the flat flow tubes 5m and 5n. When the tilt valve 4 is in an open state, the exhaust gas flows in the detour DR of the base structure 2 as indicated by a two-dot chain line in FIG. 7. Reference sign 27 in the drawing is a receiving portion that receives the valve plate 41 of the tilt valve 4 in the open state provided in the base structure 2.

When the thermal actuator 44 puts the tilt valve 4 into a closed state when the temperature of a heating target fluid which is the second fluid decreases to a predetermined temperature or lower, as indicated by a bold arrow in FIG. 7, the exhaust gas is restricted from flowing toward a side opposite to the arrangement side of the flat flow tubes 5m and 5n, the exhaust gas flows in the heat exchange path ER of the base structure 2, the exhaust gas is guided toward the arrangement side of the flat flow tubes 5m and 5n and the heat transfer fins 6 of the separator 3, the heating target fluid such as cooling water flowing in the flat flow tubes 5m and 5n while making a U-turn is heated, and heat exchange is performed.

In this case, since the upstream-side end 5m in the flowing direction of the exhaust gas, of the flat flow tube 5n of the downstream-side flat flow tube group is disposed so as not to overlap the flat flow tube 5m of the upstream-side flat flow tube group in the flowing direction of the exhaust gas, high-efficiency heat exchange is performed by both of the upstream-side flat flow tube 5m and the downstream-side flat flow tube 5n. After that, when the thermal actuator 44 detects that the temperature of the heating target fluid which has been heated and led out has reached a predetermined temperature or higher, the thermal actuator 44 puts the tilt valve 4 into an open state, the exhaust gas flows in the detour DR and the heat exchange with the heating target fluid stops.

According to the automobile exhaust heat recovery device 1 of the present embodiment, since the flat surfaces of the flat flow tubes 5m and 5n follow the flowing direction of the first fluid, and the plurality of flat flow tubes 5m and 5n are arranged side by side at intervals, a heat exchange area can be increased. Moreover, since the upstream-side end 51n in the flowing direction of the first fluid, of the downstream-side flat flow tube 5n does not overlap the upstream-side flat flow tube 5m, the first fluid having a large temperature difference from the second fluid can reach the downstream-side flat flow tube 5n and the heat exchange performance can be increased. Therefore, it is possible to enhance the heat exchange efficiency remarkably. Due to the structure in which the second fluid flows between the upstream-side flat flow tube group and the downstream-side flat flow tube group while making a U-turn, it is possible to lead a fluid that performs heat exchange such as cooling water to the same side as the introduction side and increase the degree of freedom of an installation location of the automobile exhaust heat recovery device 1 in a vehicle. Moreover, due to the flat shape and the arrangement of the flat flow tubes 5m and 5n, it is possible to reduce the pressure loss of the first fluid flowing in the base structure 2 and secure the smooth flew of the first fluid. When the first fluid is the exhaust gas of an internal combustion engine of an automobile, it is possible to reduce the back pressure of the internal combustion engine due to the reduction of the pressure loss and improve the exhaust efficiency, the intake efficiency, and the combustion efficiency of the internal combustion engine.

Since the plurality of heat transfer fins 6 are provided at intervals in the pipeline direction in which the upstream-side flat flow tube group and the downstream-side flat flow tube group extend, it is possible to further enhance the heat exchange efficiency. Since the upstream-side flat flow tube group and the downstream-side flat flow tube group are inserted into the same heat transfer fin 6, it is possible to easily integrate and assemble the upstream-side flat flow tube group and the downstream-side flat flow tube group by attachment of the heat transfer fin 6.

Introduction and lead-out of the second fluid to the upstream-side flat flow tube group and the downstream-side flat flow tube group is facilitated by the first and second partitioning portions 71 and 72. Moreover, since the U-turn partitioning portion 8 eliminates the need for a complex structure such as shifting the upstream-side flat flow tubes 5m in the stacking direction of the flat flow tubes 5m so as to be connected to the downstream-side flat flow tubes 5n, it is possible to simplify the structure for allowing the second fluid to make a U-turn and realize the structure at a low cost. Moreover, since the second fluid led out from the flat flow tubes 5m or 5n of the upstream-side or the downstream-side is mixed inside the U-turn partitioning portion 8, it is possible to promote turbulence and stirring to suppress temperature unevenness and further enhance the heat exchange efficiency.

The pair of half bodies 24a and 24b are bonded so as to be aligned in the pipeline direction of the flat flow tubes 5m and 5n to form the base structure 2, and both ends of the flat flow tubes 5m and 5n are fitted and welded to the penetration holes 26m and 26n of one half body 24a and the penetration holes 26m and 26n of the other half body 24b. Therefore, it is possible to position the flat flow tubes 5m and 5n with respect to the base structure 2 and the pair of half bodies 24a and 24b easily and reliably and fix the flat flow tubes 5m and 5n in a bridged state.

Due to the structure in which the pair of half bodies 24a and 24b are bonded so as to foe aligned in the pipeline direction of the flat flow tubes 5m and 5n to form the base structure 2, by fitting the fitting portion 241a provided in the mating portion of one half body 24a to the fitting target portion 241b provided in the mating portion of the other half body 24b, it is possible to position and align one half body 24 and the other half body 24b at an accurate position and facilitate the manufacturing operation and improve the yield.

Since the bulging portion 23 and the separator 3 are provided in the base structure 2 to separately form the heat exchange path ER and the detour DR, and the flow of the first fluid can be switched between the heat exchange path ER and the detour DR by the switching of the tilt valve 4, it is possible to form the automobile exhaust heat recovery device 1 having the switchable heat exchange path ER and the detour DR with a small number of parts. Therefore, since the number of parts to be bonded decreases, it is possible to improve the manufacturing efficiency and decrease the cost of parts and the cost of bonding operations to reduce the manufacturing cost. Moreover, since the number of parts decreases, it is possible to reduce the weight of the automobile exhaust heat recovery device 1 and improve the fuel efficiency of an automobile due to weight reduction.

The separator 3, the tilt valve 4, and the flat flow tubes 5m and 5n are bridged between the half bodies 24a and 24b. Therefore, the separator 3, the tilt valve 4, and the flat flow tubes 5m and 5n can be easily installed in the base structure 2 in cooperation with an operation of aligning the pair of half bodies 24a and 24b in the pipeline direction of the flat flow tubes 5m and 5n.

### Scope of Invention Disclosed in this Specification

The invention disclosed in this specification includes, in addition to the configurations according to respective inventions or embodiments, a matter defined by modifying any of these partial configurations into other configurations disclosed in this specification within an applicable range, a matter defined by adding any other configurations disclosed in this specification to these partial configurations, or a natter defined into a generic concept by cancelling any of these partial configurations within a limit that achieves a partial operational advantage. The invention disclosed in this specification further includes the following modifications and the added matters.

For example, the base structure of the automobile exhaust heat recovery device of the present invention is not limited to a base structure in which a pair of half bodies 24a and 24b are bonded so as to foe aligned in the pipeline direction of the flat flow tubes 5m and 5n as in the embodiment, and an automobile exhaust heat recovery device including a base structure which includes the heat exchange path only in which the heat exchange path ER and the detour DR are not switchable also falls within the automobile exhaust heat recovery device of the present invention.

In the automobile exhaust heat recovery device 1 of the embodiment, the U-turn partitioning portion 8 that can simplify the structure that allow the second fluid to make a U-turn is provided. However, an appropriate structure that can form a flow path in which the second fluid flows so as to make a U-turn between the upstream-side flat flow tube group and the downstream-side flat flow tube group also falls within the automobile exhaust heat recovery device of the present invention. The automobile exhaust heat recovery device of the present invention may include an appropriate configuration in which the upstream-side end in the flowing direction of the first fluid, of the flat flow tube of the downstream-side flat flow tube group does not overlap the flat flow tube of the upstream-side flat flow tube group in the flowing direction of the first fluid. For example, a configuration in which the thickness of the downstream-side flat flow tube is larger than the interval between the upstream-side flat flow tubes or a configuration in which the thickness of the downstream-side flat flow tube is smaller than the interval between the upstream-side flat flow tubes may be used.

In the automobile exhaust heat recovery device of the present invention, when a configuration in which the second fluid is allowed to make a U-turn to be led out to the same side as the introduction side is a structure that lead out the second fluid with one U-turn, it is preferable because the structure of the automobile exhaust heat recovery device can be simplified and be installed in a space-saving manner. However, the second fluid may be led out to the same side as the introduction side by making a plurality of odd-numbers of U-turn such as three or five times.

The first fluid and the second fluid in the automobile exhaust heat recovery device of the present invention fall within the present invention when one of the first fluid and the second fluid is a heating fluid and the other fluid is a heating target fluid. The kinds of the heating fluid and the heating target fluid are optional, and the heating fluid may be liquid, steam, or the like other than exhaust gas.

### INDUSTRIAL APPLICABILITY

The present invention can be used, for example, when exhaust heat is recovered from an exhaust gas of an internal combustion engine of an automobile.

### REFERENCE SIGNS LIST

1: Automobile exhaust heat recovery device

2: Base structure

21: Fluid introducing portion

22: Fluid lead-out portion

23: Bulging portion

24a, 24b: Half body

241a: Fitting portion

241b: Fitting target portion

25: Wall portion

251: Mounting portion

26m, 26n: Penetration hole

261n: Upstream-side end

27: Receiving portion

3: Separator

31: Side wall

311: Recess

4: Tilt valve

41: Valve plate

42: Shaft portion

43: Driving plate

431: Projection

44: Thermal actuator

441: Driving lever

5m, 5n: Flat flow tube

51n: Upstream-side end

52, 53: Plate

54: Supporting portion

6: Heat transfer fin

61: Insertion hole

62: Tapered edge

7: Partitioning unit

71: First partitioning portion

711: Connection hole

72: Second partitioning portion

721: Connection hole

73, 74: Pipe

8: U-turn partitioning portion

ER: Heat exchange path

DR: Detour

1-7. (canceled)

8. An automobile exhaust heat recovery device comprising:
a base structure in which first fluid flows; and
flat flow tubes which extend at an angle with respect to a flowing direction of the first fluid and in which a flat surface is provided so as to follow the flowing direction of the first fluid and second fluid that exchanges heat with the first fluid flows,
an upstream-side flat flow tube group and a downstream-side flat flow tube group in the flowing direction of the first fluid are configured such that a plurality of flat flow tubes are arranged side by side at intervals in a direction substantially perpendicular to the flowing direction of the first fluid,
an upstream-side end in the flowing direction of the first fluid, of the flat flow tube of the downstream-side flat flow tube group is provided so as not to overlap the flat flow tube of the upstream-side flat flow tube group in the flowing direction of the first fluid, and
a flow path through which the second fluid flows is configured so as to make a U-turn between the upstream-side flat flow tube group and the downstream-side flat flow tube group.

9. The automobile exhaust heat recovery device according to claim 8, wherein
the upstream-side flat flow tube group and the downstream-side flat flow tube group are collectively inserted into the same heat transfer fin, and
a plurality of heat transfer fins are provided at intervals in a pipeline direction in which the upstream-side flat flow tube group and the downstream-side flat flow tube group extend.

10. The automobile exhaust heat recovery device according to claim 8, further comprising:
a first partitioning portion in which openings at one set of ends of the flat flow tubes of the upstream-side flat flow tube group are open; and
a second partitioning portion in which openings at one set of ends of the flat flow tubes of the downstream-side flat flow tube group are open and which is partitioned from the first partitioning portion, wherein
the second fluid is introduced from the outside into one of the first and second partitioning portions, and the second fluid is led outside from the other partitioning portion, and
a U-turn partitioning portion in which openings at the other set of ends of the flat flow tubes of the upstream-side flat flow tube group and openings at the other set of ends of the flat flow tubes of the downstream-side flat flow tube group are open is provided.

11. The automobile exhaust heat recovery device according to claim 9, further comprising:
a first partitioning portion in which openings at one set of ends of the flat flow tubes of the upstream-side flat flow tube group are open; and
a second partitioning portion in which openings at one set of ends of the flat flow tubes of the downstream-side flat flow tube group are open and which is partitioned from the first partitioning portion, wherein
the second fluid is introduced from the outside into one of the first and second partitioning portions, and the second fluid is led outside from the other partitioning portion, and
a U-turn partitioning portion in which openings at the other set of ends of the flat flow tubes of the upstream-side flat flow tube group and openings at the other set of ends of the flat flow tubes of the downstream-side flat flow tube group are open is provided.

12. The automobile exhaust heat recovery device according to claim 8, wherein
the base structure is formed by bonding a pair of half bodies so as to be aligned in a pipeline direction of the flat flow tubes, and
both ends of the flat flow tubes are fitted and welded to a penetration hole of one half body and a penetration hole of the other half body.

13. The automobile exhaust heat recovery device according to claim 9, wherein
the base structure is formed by bonding a pair of half bodies so as to be aligned in a pipeline direction of the flat flow tubes, and
both ends of the flat flow tubes are fitted and welded to a penetration hole of one half body and a penetration hole of the other half body.

14. The automobile exhaust heat recovery device according to claim 10, wherein
the base structure is formed by bonding a pair of half bodies so as to be aligned in a pipeline direction of the flat flow tubes, and
both ends of the flat flow tubes are fitted and welded to a penetration hole of one half body and a penetration hole of the other half body.

15. The automobile exhaust heat recovery device according to claim 11, wherein
the base structure is formed by bonding a pair of half bodies so as to be, aligned in a pipeline direction of the flat flow tubes, and
both ends of the flat flow tubes are fitted and welded to a penetration hole of one half body and a penetration hole of the other half body.

16. The automobile exhaust heat recovery device according to claim 8, wherein
the base structure is formed by bonding a pair of half bodies so as to be aligned in a pipeline direction of the flat flow tubes, and
a fitting portion provided in a mating portion of one half body is fitted to a fitting target portion provided in a mating portion of the other half body.

17. The automobile exhaust heat recovery device according to claim 9, wherein
the base structure is formed by bonding a pair of half bodies so as to be aligned in a pipeline direction of the flat flow tubes, and
a fitting portion provided in a mating portion of one half body is fitted to a fitting target portion provided in a mating portion of the other half body.

18. The automobile exhaust heat recovery device according to claim 10, wherein
the base structure is formed by bonding a pair of half bodies so as to be aligned in a pipeline direction of the flat flow tubes, and
a fitting portion provided in a mating portion of one half body is fitted to a fitting target portion provided in a mating portion of the other half body.

19. The automobile exhaust heat recovery device according to claim 11, wherein
the base structure is formed by bonding a pair of half bodies so as to be aligned in a pipeline direction of the flat flow tubes, and
a fitting portion provided in a mating portion of one half body is fitted to a fitting target portion provided in a mating portion of the other half body.

20. An automobile exhaust heat recovery device according to claim 8, further comprising
the base structure which includes a fluid introducing portion, a fluid lead-out portion, and a bulging portion between the fluid introducing portion and the fluid lead-out portion and which is formed by bonding a pair of half bodies so as to be aligned in a pipeline direction of the flat flow tubes;
a separator that extends in the flowing direction of the first fluid flowing in the base structure and divides the inside of the bulging portion substantially into a heat exchange path and a detour; and
a tilt valve that is switchable so that the flow of the first fluid flowing in the base structure is regulated to either the heat exchange path or the detour, wherein
the upstream-side flat flow tube group and the downstream-side flat flow tube group are provided such that the first fluid flowing in the heat exchange path flows around the flat flow tube groups.

21. An automobile exhaust heat recovery device according to claim 9, further comprising
the base structure which includes a fluid introducing portion, a fluid lead-out portion, and a bulging portion between the fluid introducing portion and the fluid lead-out portion and which is formed by bonding a pair of half bodies so as to be aligned in a pipeline direction of the flat flow tubes;
a separator that extends in the flowing direction of the first fluid flowing in the base structure and divides the inside of the bulging portion substantially into a heat exchange path and a detour; and
a tilt valve that is switchable so that the flow of the first fluid flowing in the base structure is regulated to either the heat exchange path or the detour, wherein
the upstream-side flat flow tube group and the downstream-side flat flow tube group are provided such that the first fluid flowing in the heat exchange path flows around the flat flow tube groups.

22. An automobile exhaust heat recovery device according to claim 10, further comprising
the base structure which includes a fluid introducing portion, a fluid lead-out portion, and a bulging portion between the fluid introducing portion and the fluid lead-out portion and which is formed by bonding a pair of half bodies so as to be aligned in a pipeline direction of the flat flow tubes;
a separator that extends in the flowing direction of the first fluid flowing in the base structure and divides the inside of the bulging portion substantially into a heat exchange path and a detour; and
a tilt valve that is switchable so that the flow of the first fluid flowing in the base structure is regulated to either the heat exchange path or the detour, wherein
the upstream-side flat flow tube group and the downstream-side flat flow tube group are provided such that the first fluid flowing in the heat exchange path flows around the flat flow tube groups.

23. An automobile exhaust heat recovery device according to claim 11, further comprising
the base structure which includes a fluid introducing portion, a fluid lead-out portion, and a bulging portion between the fluid introducing portion and the fluid lead-out portion and which is formed by bonding a pair of half bodies so as to be aligned in a pipeline direction of the flat flow tubes;
a separator that extends in the flowing direction of the first fluid flowing in the base structure and divides the inside of the bulging portion substantially into a heat exchange path and a detour; and
a tilt valve that is switchable so that the flow of the first fluid flowing in the base structure is regulated to either the heat exchange path or the detour, wherein
the upstream-side flat flow tube group and the downstream-side flat flow tube group are provided such that the first fluid flowing in the heat exchange path flows around the flat flow tube groups.

24. The automobile exhaust heat recovery device according to claim 20, wherein the separator, the tilt valve, and the flat flow tube are bridged between the half bodies.

25. The automobile exhaust heat recovery device according to claim 21, wherein the separator, the tilt valve, and the flat flow tube are bridged between the half bodies.

26. The automobile exhaust heat recovery device according to claim 22, wherein the separator, the tilt valve, and the flat flow tube are bridged between the half bodies.

27. The automobile exhaust heat recovery device according to claim 23, wherein the separator, the tilt valve, and the flat flow tube are bridged between the half bodies.
